(19) United States
(12) Patent Application Publication
(10) Pub. No.: US 2021/0282562 A1
(43) Pub. Date: Sep. 16, 2021

(54) ADJUSTABLE AND COLLAPSIBLE SUPPORT BED OR TABLE

(71) Applicant: SHANGHAI XINTANG INDUSTRIAL CO., LTD., Shanghai (CN)

(72) Inventor: Chuankui DU, Shanghai (CN)

(21) Appl. No.: 16/495,303

(22) PCT Filed: Jun. 30, 2017
(86) PCT No.: PCT/IB2017/053988

§ 371 Date: Sep. 18, 2019

(30) Foreign Application Priority Data
Mar. 18, 2017 (CN) 2017301860739
May 26, 2017 (CN) 201720602067.1

(51) Int. Cl. A47C 17/68; A47C 17/78

(52) U.S. Cl. CPC A47C 17/68; A47C 17/78

(57) ABSTRACT

A portable care bed or support table, including a sheet board, bed legs, support rods, and wire ropes. Each bed leg may include supporting legs and adjustable legs. When using the bed in an expanded position, it is possible to adjust the height of the bed by adjusting the height of those holes. Bed legs are connected to the sheet board by fasteners. Support rods include long support rods and short support rods connected together. Long support rods are connected to the sheet board by fasteners, while short support rods are connected to bed legs by wire ropes, forming multiple triangles for support. Also, using wire ropes makes the triangle-shaped supports stronger. To move the bed to its collapsed position, support rods are folded at connecting spots or joints between long support rods and short support rods. The bed legs are folded via hinges.

### CROSS-REFERENCE TO RELATED APPLICATIONS

This application is a national stage application, filed under 35 U.S.C. § 371, of PCT Application No. PCT/IB2017/053988, filed on Jun. 30, 2017, which claims priority to Chinese Application 201720602067.1 filed May 26, 2017 and Chinese 201730186073.9 filed May 18, 2017, which are hereby incorporated by reference in their entireties.

### BACKGROUND

### Field

This disclosure is generally related to a support bed or table that is adjustable and portable, as well as foldable between expanded and collapsed positions.

### Description of Related Art

In many emergency rescue situations, emergency rescue is carried out on the ground. For example, if a patient has a leg cramp, they tend to fall to the ground. Rescue personnel thus usually have to conduct rescue work on the ground, including being able to use equipment to assist a patient, which makes it difficult to carry out rescue work. When that happens, i.e., a patient is on the ground, it is necessary to have a platform for the rescue workers that is easy to use.

### SUMMARY

One aspect of this disclosure is to provide a portable and collapsible support bed. The bed includes a sheet board having a top flat surface, a plurality of legs connected to an underside of the sheet board via hinges, support rods whose ends are connected to the underside of the sheet board and to one of the plurality of legs via hinged connections at each end, and wire ropes connected to one of the plurality of legs and the support rods. The bed is configured for movement between an expanded position and a collapsed position. The plurality of legs, support rods, and wire ropes are positioned away from the sheet board in the expanded position. In the collapsed position, the plurality of legs, support rods, and wire ropes are positioned adjacent to the underside of the sheet board.

Other features and advantages of the disclosure will become apparent from the following detailed description, the accompanying drawings, and the appended claims.

### BRIEF DESCRIPTION OF THE DRAWINGS

FIG. 1 is a schematic of the structure of a support bed in an extended or standing position, in accordance with an embodiment of this disclosure;

FIG. 2 is an exploded view of the bed of FIG. 1 showing a sheet board separated from its legs, supporting legs, and wires;

FIG. 3 is a schematic of one side of the bed as shown in FIG. 1 (the opposite side being a mirror image thereof);

FIG. 4 is a view of the bed of FIG. 1 from beneath;

FIG. 5 is a schematic drawing illustrating via arrows a method for folding the bed of FIG. 1 by moving parts such that the bed is placed into its collapsed position;

FIG. 6 is a schematic of an underside of the bed of FIG. 1 in a folded position;

FIG. 7 is an exploded view showing parts of the sheet board used in the bed of FIG. 1 in accordance with an embodiment; and

FIGS. 8 and 9 illustrate a detailed view and an exploded view of that detail, respectively, of a portion of the structure of material used to form the sheet board of the bed shown in FIG. 1, in accordance with an embodiment.

FIG. 10 illustrates a detailed view of a hinged connector for a support rod of the disclosed bed of FIG. 1, in accordance with one embodiment.

FIG. 11 illustrates exemplary steps for securing a blind rivet.

FIG. 12 illustrates a detailed view of a fastener and wire rope secured at a leg of the bed of FIG. 1, in accordance with an embodiment.

FIGS. 13 and 14 illustrate detailed views of a joint in the bed of FIG. 1, in accordance with an embodiment herein.

### DETAILED DESCRIPTION

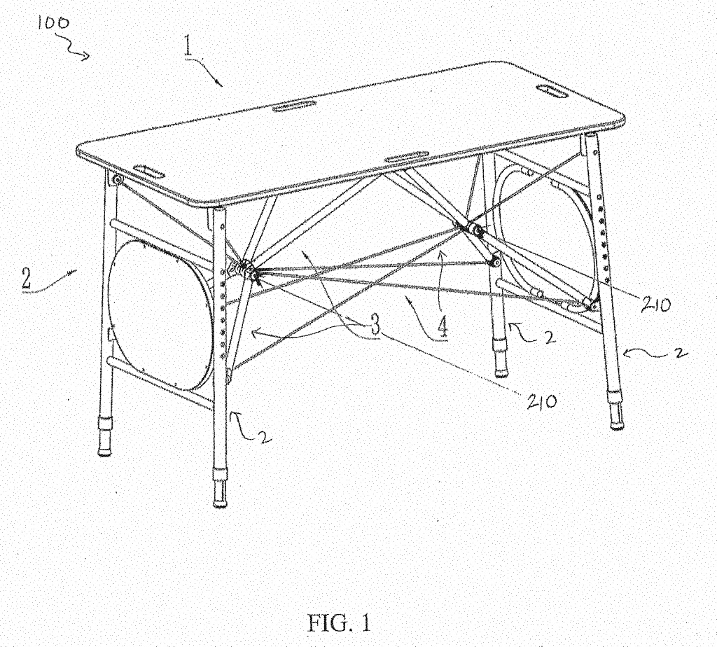

FIG. 1 shows a portable, adjustable, and collapsible care bed 100 or support table, in its expanded position, in accordance with an embodiment herein. Generally, the bed 100 includes a sheet board 1 connected to a frame, wherein the frame includes a number of bed legs 2, support rods 3, and wire ropes 4. As further understood by the description below, the bed 100 is configured for movement between an expanded position (e.g., see FIG. 1) wherein the bed legs 2, support rods 3, and wire ropes 4 are positioned relatively away from an underside of the sheet board 1, and a collapsed position (e.g., see FIG. 6), wherein the bed legs 2, support rods 3, and wire ropes 4 are positioned adjacent to the underside of the sheet board 1. In the expanded position, the bed 100 further allows for height adjustment, while in the collapsible position, the bed 100 provides greater portability.

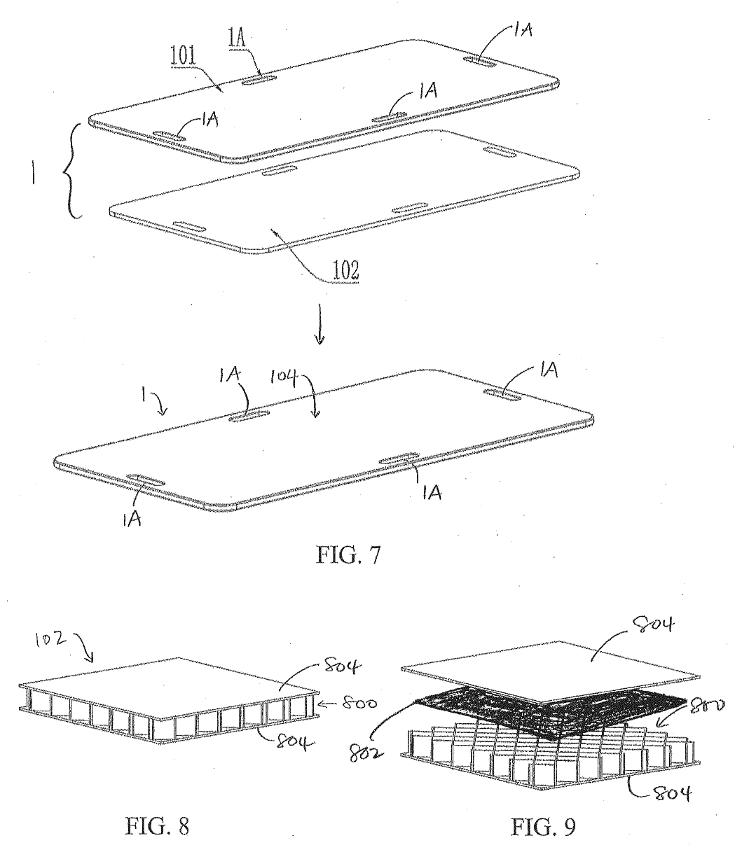

The sheet board 1 may be a generally rectangular platform extending a length in a longitudinal direction (see centerline A in FIGS. 2 and 4) and a width in a lateral direction (see centerline C in FIG. 4). The sheet board 1 includes a top end, bottom end, a right side (i.e., on the right of centerline A in FIG. 2) and a left side (i.e., on the left of centerline A in FIG. 2), with a top flat surface 104 and an underside surface. The flat surface 104 may be configured to receive a person or items thereon, for example. The sheet board 1 has hand holes 1A, which make it more convenient for people to grip the sheet board. Hand holes 1A may be provided near edges on each side of the rectangular platform, for example, near top and bottom ends and/or near right and left sides of the sheet board 1 (e.g., see FIGS. 2 and 7).

In accordance with one embodiment, represented in FIG. 7, for example, the bed sheet board 1 employs a light material 102 and plastic coating 101, which reduces the weight of the sheet board 1 while ensuring the carrying capacity thereof. Accordingly, this makes the entire product lighter. The product's weight may be more than 30% lighter than traditional products, for example. As compared to traditional plastic materials used to make such boards which traditionally weigh approximately 22 lbs., the material 102 of sheet board 1 may weigh approximately 10 lbs, in accordance with embodiments.

FIGS. 8 and 9 illustrate exemplary details of a portion of a structure that may be used to form the light material 102 of the sheet board 1 of the bed 100 shown in FIG. 1, in accordance with an embodiment. For example, material 102 may include a core material 800 with one or more surface layer(s) 804 applied thereto. As shown in FIGS. 8 and 9, a surface layer 804 may be applied to either side of the core material 800. In an embodiment, the core material 800 may be provided in the form of a honeycomb board, e.g., made of aluminum or similar light metal. The surface layer(s) 804 may be formed from a fiber-based fabric, such as carbon fiber fabric or fiber glass fabric, in accordance with an embodiment. A highly adhesive film(s) or layer(s) 802 (e.g., see FIG. 9) may be used to attach the surface layer(s) 804 to the core material 800 to form material 102. The material 102 of the sheet board 1 may be configured such that its surfaces can bend and retract. The plastic coating 101 also makes it more comfortable for people when coming into contact with the sheet board 1 and produces a greater sense of product quality. In accordance with some embodiments, the plastic coating 101 may include thermoplastic rubber material (TPR), acrylonitrile butadiene styrene (ABS), polypropylene (PP), and/or polyamides plastic, or similar materials.

The frame connected to the sheet board 1 includes a number of support structures designed to support the weight of person on the sheet board 1 when the bed 100 is in the expanded position. A multiple number of bed legs 2—e.g., four as shown in the Figures, one near each corner of the sheet board 1—are connected to an underside of the sheet board 1 via fasteners 203 that include hinges that allow the legs 2 to rotate relative to the sheet board 1. The legs 2 may be provided and connected in pairs on either side (top side and bottom side) of the sheet board 1. Fasteners 203 may be provided in the form of an L-shaped portion, for example, as shown in the illustrative embodiment, wherein a horizontal plate part may be connected to an underside of the sheet board 1 via screws, bolts, or the like, and a vertical plate part may be connected to part of the bed leg 2 via a hinged connector. The hinged connector used to secure the bed leg 2 with the fastener 203 includes a rotatable portion that may be configured to enable the rotation of the leg 2 towards and away from an underside of the sheet board 1.

Optionally, horizontal braces and/or side supports may be positioned between two bed legs 2 on either side of the bed 100 (e.g., shown in FIG. 1). Such devices may provide further support and stability to the bed legs 2, for example, when the bed 100 is in its expanded position.

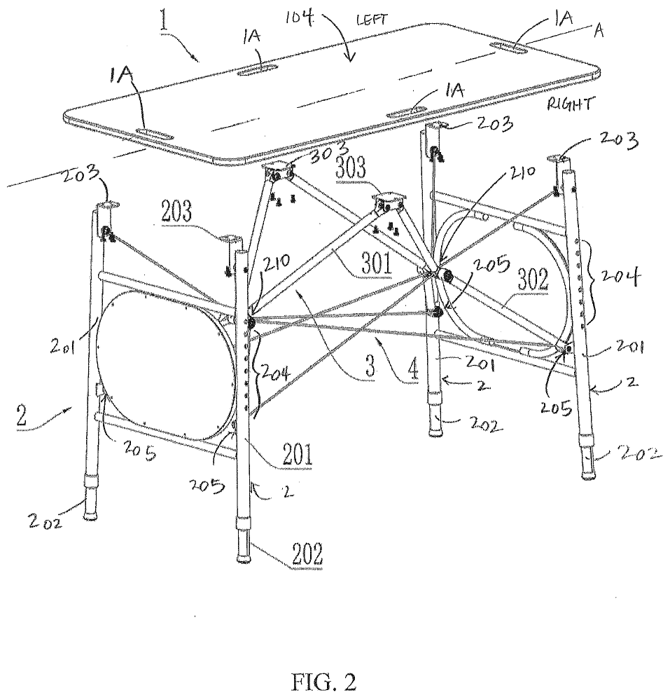

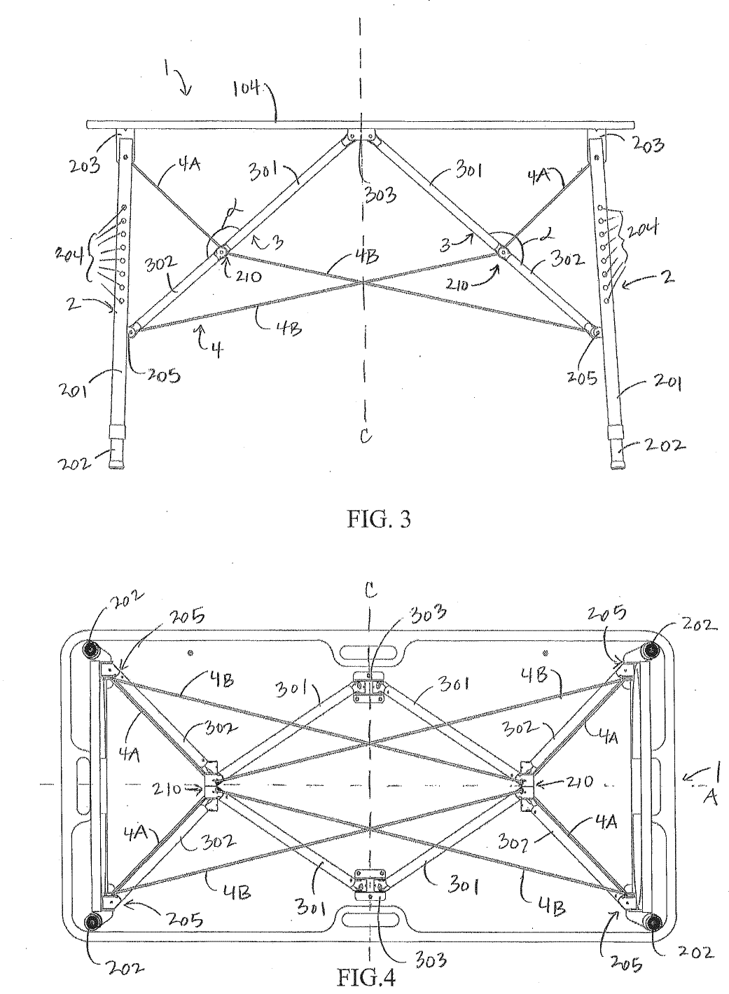

Each bed leg 2 includes a support leg portion 201 (or supporting leg 201) and an adjustable leg portion 202 (or adjustable leg 202), as shown in FIGS. 2 and 3, for example. The supporting leg 201 may be connected, e.g., at its top, to the underside of the sheet board 1 via the hinged connectors of fasteners 203. The supporting leg 201 may be in the form of a tube with a central opening, for example. The adjustable leg 202 may be provided within the opening of the supporting leg 201 such that it is configured to move within and relative to a bottom of the supporting leg 201. The movement of adjustable leg 202 enables adjustment of a (vertical) height of the sheet board 1, e.g., relative to a floor or ground, in its expanded position. There may be several holes 204 on each supporting leg 201, and bead clamps may be installed on each adjustable leg for movement into one of the holes 204 of the supporting leg 201 such that the adjustable leg 202 may be locked in a (vertical) position relative to the support leg 201. As generally understood by one of ordinary skill in the art, such clamps may include a bead or rounded locking portion that is biased using one or more springs, and designed to lock in place by moving into a respective hole or opening. Generally, to unlock the clamp, the bead or rounded locking portion can be pushed or moved against the bias of the spring (i.e., compressing the spring) such that it can be slid out of the respective hole or opening. The adjustable legs 202 may be rounded for vertical movement within the tube of support leg 201. In addition, the legs 202 may be rounded because it is difficult for beads on adjustable legs 202 to turn to the same surface with the holes 204 on supporting legs 201; thus rounding the legs 202 allows for movement or rotation of the legs 202 within support leg 201, so that the bead can be aligned with an inserted into one of the holes 204. When using the bed 100, it is possible to adjust the height of the sheet board 1 and/or bed 100 by adjusting the position of the bead clamp of the adjustable legs 202 within those holes 204.

In accordance with another embodiment, there may be holes provided on the adjustable leg 202 that are configured to be aligned with the holes 204 on the support leg 201, so that a clamp, key, or similar locking device may be inserted into the aligned holes of the legs to secure and lock the position of the adjustable leg 202 within the supporting leg 201.

In accordance with an embodiment, the adjustable legs may have direction identification slots and/or one or more marks for identifying the direction needed for movement rotation, for example.

Referring back to FIG. 1, support rods 3 have ends that are connected to the underside of the sheet board 1 and to one of the bed legs 2. More specifically, the ends of the support rods 3 may be connected to both the sheet board 1 and legs 2 via hinged connections, allowing for hinged movement at each end of the support rods 3. As seen in FIG. 3, for example, the support rods 3 may be positioned and connected to the sheet board 1 and the legs 2 in a triangular shaped configuration when viewed from a side of the bed in the expanded position.

In an embodiment, the support rods 3 include one or more first support rods 301 and second support rods 302. In one embodiment, the first support rod 301 is relatively longer in length than a length of the second support rod 302. A first end of each first support rod 301 may be connected to the underside of the sheet board 1 via fasteners 303 providing a hinged connection. Fasteners 303 may be spaced apart from one another and positioned at side edges of the sheet board 1, e.g., near a centerline extending in a lateral direction between the side edges (e.g., through a width of the sheet board 1, wherein a length of the sheet board 1 extends in a longitudinal direction and is greater than the width), or near the side hand holes 1A. A first end of each second support rod 302 may be connected to the one of the bed legs 2 by hinged connectors 205. The connection of the first support rods 302 to the sheet board 1 and the connection of the second support rods 302 to the legs 2 form multiple triangles for support (in the expanded position of bed 100). Further, as explained in greater detail below, when wire ropes 4 are used to make connections therewith, the triangle-shaped supports of bed 100 are further strengthened.

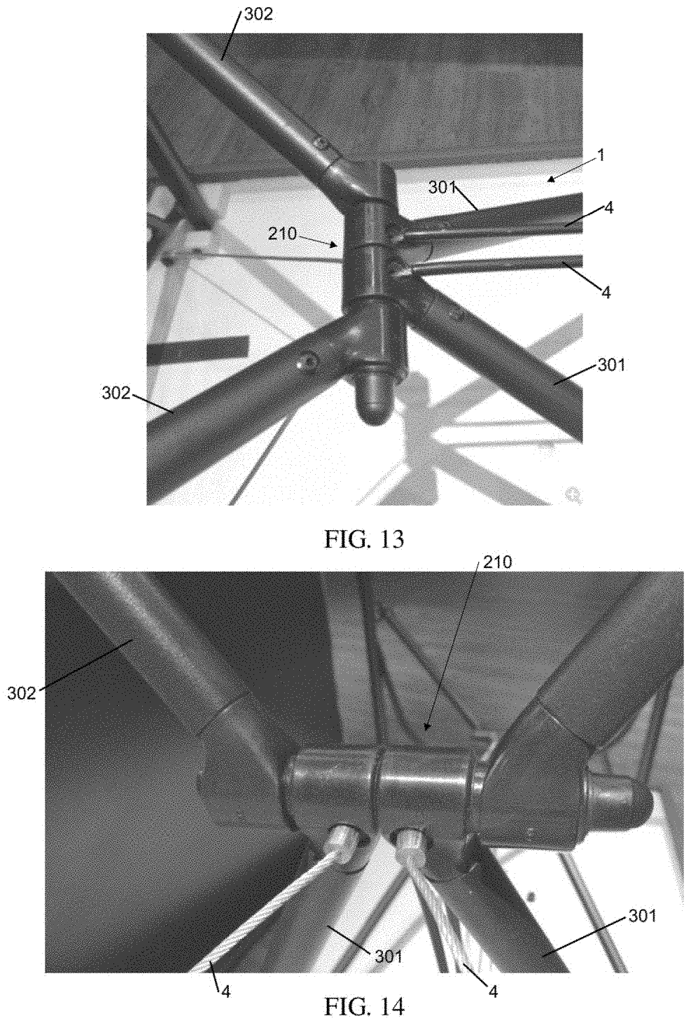

Second ends of the first support rods 301 and the second support rods 302 are designed to be pivotally connected to each other at joints 210. In accordance with an embodiment, for example, the ends of the rods 301 and 302 may include end connectors that may be aligned and pinned together using a pin. The joints 210 are designed to allow relative rotation of at least the first support rods 301 and the second support rods 302 about an axis. FIGS. 13 and 14, noted later, illustrate detailed views of the connectors and fasteners used to form such joints 210, in accordance with an embodiment.

In the illustrated embodiment, two pairs of first support rods 301 (or four first support rods 301) and two pairs of second support rods 302 (or four second support rods 302) may be part of the support legs 3 included in the frame of bed 100. For example, with reference to FIG. 4, a first pair of first support rods 301 is viewed as being provided on a left side of lateral centerline C and a second pair of first support rods 301 is provided on a right side of lateral centerline C. As shown in FIGS. 2 and 3 (FIG. 3 showing only one representative side of the bed 100), the ends of each of the first support rods 301 may be connected to fasteners 303. Specifically, in the above-noted first pair of first support rods 301 (i.e., pair provided on a left side of lateral centerline C in FIG. 4) one support rod 301 (e.g., a left support rod, to the left of centerline A as shown in FIG. 2) may be connected to fastener 303 on a left side of the sheet board 1 and the other support rod 301 in the pair (e.g., a right support rod, to the right of centerline A) may be connected to fastener 303 on a right side of the sheet board 1. At their opposite ends, these support rods 301 of the first pair may be connected at joint 210 (provided to the left of the lateral centerline C in FIG. 4, closer to a bottom end of the sheet board 1). For the second pair of first support rods 301 (i.e., pair provided on a right side of lateral centerline C in FIG. 4) one support rod 301 (e.g., a left support rod, to the left of centerline A as shown in FIG. 2) may be also connected to fastener 303 on a left side of the sheet board 1 and the other support rod 301 (e.g., a right support rod, to the right of centerline A) in the pair may be also connected to fastener 303 on a right side of the sheet board 1. At their opposite ends, the support rods 301 of the second pair may be connected at another, separate joint 210 (provided to the right of the lateral centerline C in FIG. 4, closer to a top end of the sheet board 1). Accordingly, each pair of the first support rods forms a triangle-shaped support with respect to the (underside surface of) sheet board 1.

Although more than one first support rod 301 may be connected to a fastener 303, each support rod 301 may be configured to rotate via hinges that may be part of or connected to the fasteners 303.

As shown in FIG. 3, the joints 210 of each pair of the first support rods 301 may be separate joints positioned near opposite ends (near top and bottom) of the sheet board 1. As previously noted, the joints 210 connect the first support rods 301 to the second support rods 302 such that they may pivot relative to each other. In accordance with an embodiment, the two pairs of second support rods 302 may also be connected at these joints 210. That is, each pair of the second support rods 302 may have an end that may be pivotally connected one of the joints 210, while the other ends of the rods 302 may be connected to one of the legs 2. Accordingly, each pair of second support rods 302 may form a triangle-shaped support with respect to the legs 2.

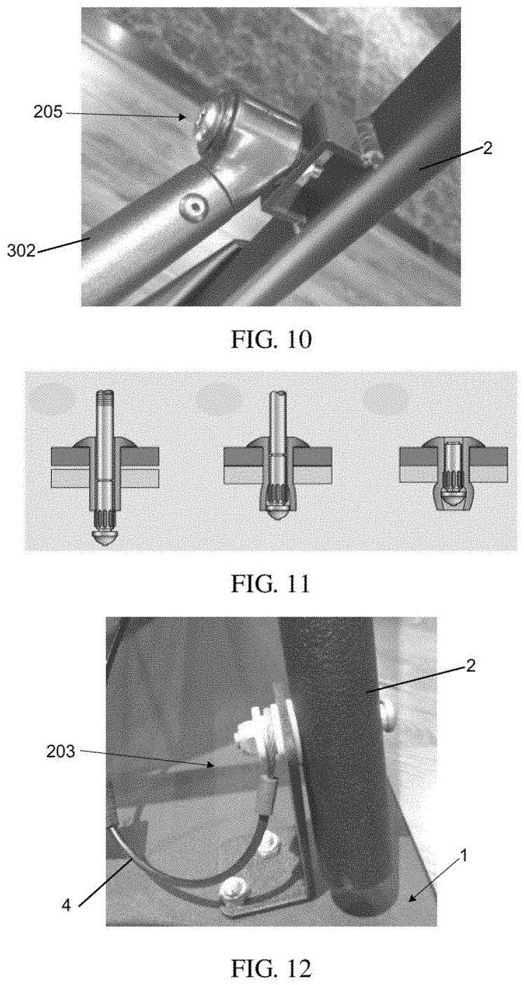

For example, with reference to FIG. 4, a first pair of second support rods 302 may be viewed as being provided on a left side of lateral centerline C and a second pair of second support rods 302 may be provided on a right side of lateral centerline C. As shown in FIGS. 2 and 3, the ends of each of the second support rods 302 may be connected to hinged connectors 205, e.g., a rotating connection portion that may be secured to the leg 2 (e.g., via a bracket and nuts and bolt). FIG. 10 illustrates a detailed view of a hinged connector 205, in accordance with one embodiment. The hinged connectors 205 may be provided at a lower position on the legs 2 relative to an upper position of fasteners 203 on the legs 2. Specifically, in the above-noted first pair of second support rods 302 (i.e., pair provided on a left side of lateral centerline C in FIG. 4), one of the support rods 302 (e.g., a left support rod, to the left of centerline A as shown in FIG. 2) may be connected to a hinged connector 205 provided on a lower left side of the left leg 2 near the bottom of the bed 100 (or lower left corner) and the other support rod 302 (e.g., a right support rod, to the right of centerline A) in the pair may be connected to hinged connector 205 provided on a lower right side of the right leg 2 near the bottom of the bed 100 (or lower right corner). At their opposite ends, these support rods 302 of the first pair may be connected at left joint 210 (closer to a bottom end of the sheet board 1) with the pair of first support rods 301. For the second pair of second support rods 302 (i.e., pair provided on a right side of lateral centerline C in FIG. 4) one support rod 302 (e.g., a left support rod, to the left of centerline A as shown in FIG. 2) may be connected to a hinged connector 205 provided on a lower left side of the left leg 2 near the top of the bed 100 (or top left corner) and the other support rod 302 (e.g., a right support rod, to the right of centerline A) in the pair may be connected to hinged connector 205 provided on a lower right side of the right leg 2 near the top of the bed 100 (or top right corner). At their opposite ends, these support rods 302 of the second pair may be connected at right joint 210 (closer to a top end of the sheet board 1) with the pair of first support rods 301. Accordingly, each pair of the second support rods forms a triangle-shaped support with respect to the legs 2.

In addition to the legs 2 and support rods 3 (i.e., 301 and 302), the frame of the bed 100 also includes wire ropes 4 that may be connected to both one of the legs 2 and to the support rods 3, generally shown in FIG. 1. Although the term “wire rope” is used herethroughout, it should be understood that wire rope is intended to refer to a rope, a cable, or a wire, which may or may not be wound with other wires, for example; accordingly, the term wire rope is not intended to be limiting. The cables or wire ropes 4 may be formed from materials such as steel or stainless steel, for example.

In accordance with an embodiment, each of the wire ropes 4 of the frame may be connected to one of the legs 2 and one of the joints 210. For example, at least two pairs of the wire ropes 4 may be provided, wherein each pair of the wire ropes 4 has one wire rope whose first end may be connected to a leg and whose second (opposite) end may be connected at one of the joints 210, while the second wire rope has a first end connected to a different leg and its second (opposite) end may be also connected at the same one of the joints 210 (e.g., one wire is connected to a right leg and one wire is connected to a left leg at one end, while the other ends may be together at the joint 210). Accordingly, each pair of wire ropes 4 may form a substantially V-shaped support. In one embodiment, the wire ropes 4 may be connected to the joints 210 and the legs 2 in a triangular shaped configuration.

In the exemplary illustrated embodiment, four pairs of wire ropes 4 are provided, e.g., upper wire ropes 4A and lower wire ropes 4B as shown in FIGS. 3, 4, and 5. In this case, “upper” and “lower” are not intended to be limiting; rather, it is descriptive only in that “upper” refers to the wire ropes shown in the Figures as being generally positioned to extend above a joint 210 in an upper (or upward) direction from the joint 210 when the bed 100 is in its expanded position (as viewed from the side in FIG. 3, for example) and “lower” refers to the wire ropes shown in the Figures as being generally positioned to extend below a joint 210 in an lower (or downward) direction below a joint 210 when the bed 100 is in its expanded position. For the upper wire ropes 4A, each upper rope 4A has one end connected to a leg 2 via fastener 203 while its opposite end may be connected to a proximal joint 210, i.e., the joint 210 that is on the same side of the centerline C as the leg 2 it is connected to. For the lower wire ropes 4B, one end may be connected to a leg 2 via connector 205 while its opposite end may be connected to a distal joint 210, i.e., the joint 210 that is on the opposite side of the centerline C as compared to the side of the leg 2 it is connected to.

FIG. 12 shows a detailed view of one embodiment having a wire rope 4 secured at each fastener 203 of a leg 2. The wire rope 4 has an end that may be looped and placed within a groove on a part of the fastener 203, and the configuration may be secured to the leg 2 with a nut and bolt, for example. A similar configuration may be used to secure a wire rope 4 to the hinged connectors 205, in accordance with an embodiment. For example, a part may be provided on or with connector 205 that includes a groove therein such that a wire rope may be looped and secured at connector 205. However, the device or parts used to connect the wire ropes 4 to either fastener 203 or hinged connector 205, or both, are not intended to be limited to the examples provided and shown in FIGS. 10 and 12.

FIGS. 13 and 14 illustrate detailed views of a joint 210, respectively, in accordance with an embodiment herein. For example, ends of first support rods 301 may be positioned next to one another and flanked (at either end) by ends of second support rods 302. Wire ropes 4 may be connected at tops and bottoms of the joint 210, e.g., secured to rods 301, through their ends as shown in the Figures. FIG. 13 shows an underside view of wire ropes 4 connected to a bottom of a joint (e.g., ends of wire rope 4 may be of lower wire ropes connected to a distal joint, described below). FIG. 14 shows an example for connecting wires 4 to a top of a joint (e.g., ends of wire ropes 4 may be of upper wire ropes connected to a proximal or adjacent joint, also described below). As previously described, in one embodiment, ends of the support rods 301 and 302 may be connected to one another via a pin (or similar device) that allows for relative rotation of the around the axis. In an embodiment, the rods 301, 302 and wire ropes 4 may be connected at the joint 210 using blind rivets (including a rivet body and a setting portion). FIG. 11 illustrates an example of steps for attaching parts using a blind rivet, as generally understood in the art.

With reference to FIG. 4, in accordance with an embodiment, a first pair of upper wire ropes 4A may be provided on a left side of lateral centerline C and a second pair of upper wire ropes 4A may be provided on a right side of lateral centerline C of the bed 100. Each of the four upper wire ropes 4A may be connected at its first end to a different fastener 203 on each of the four legs 2 (provided near a corner of the sheet board 1 (see FIG. 2)). For the pair of wire ropes 4A provided on a left side of lateral centerline C in FIG. 4, the second ends of the upper wire ropes 4A may be connected at left joint 210 (i.e., the joint 210 to the left of centerline C in FIG. 4). For the pair provided on the right side of lateral centerline C, the second ends of the upper wire ropes 4A may be connected to right joint 210 (i.e., the joint 210 to the right of centerline C as shown in FIG. 4).

For the two bottom pairs of the lower wire ropes 4B, each of the wire ropes 4B may be connected at their one ends to legs 2 adjacent one end of the sheet board 1 and connected at their opposite ends to a distal joint 210 provided closer to another end of the sheet board 1. Specifically, each of the four lower wire ropes 4B may be connected at its first end to a different connector 205 on each of the four legs 2 (provided near a corner of the sheet board 1 (see FIG. 2)). For the pair of wire ropes 4A provided on a left side of lateral centerline C in FIG. 4, the second ends of the upper wire ropes 4A may be connected at a distal or right joint 210 (i.e., the joint 210 to the right of centerline C in FIG. 4), not the proximally positioned left joint 210. For the pair provided on the right side of lateral centerline C, the second ends of the upper wire ropes 4A may be connected to left joint 210 (i.e., the joint 210 to the left of centerline C as shown in FIG. 4), not the proximally positioned right joint 210.

Connecting the wire ropes in the described manner strengthens the triangle-shaped supports when the bed 100 is in the expanded position. When the bed 100 is setup in the expanded position, the wire ropes 4 are tight and in tension. When legs 2 are folded to the collapsed position, tension in the wire ropes 4 is released and they are configured for folding with the legs 2 towards to the support bed 1.

The bed 100 is locked in an expanded position, i.e., set up for use, as shown in FIG. 3 when the support rods 3 are pulled as far away from the sheet board 1 as allowable, because the support rods 3 (i.e., first support rods 301 and second support rods 302) are relatively positioned at an angle a that is approximately 180 degrees or less.

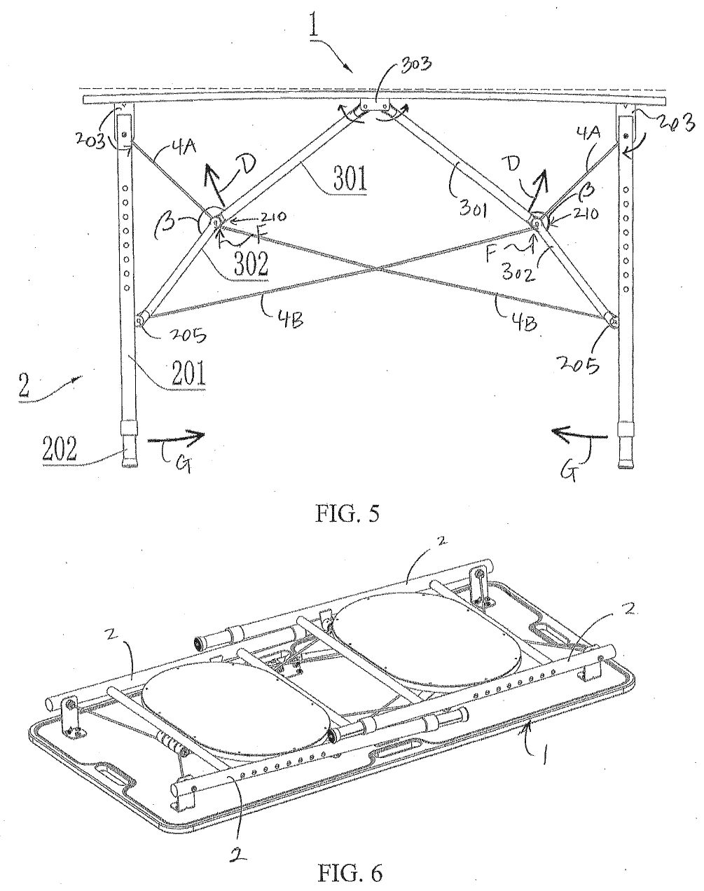

FIG. 5 is a schematic drawing illustrating via arrows a method for folding the bed 100 from its expanded position by moving parts such that the bed 100 may be placed into its collapsed position, as shown in FIG. 6. When folding the bed to a collapsed position, support rods 3 may be forcefully pushed inward at the connecting spots or joints 210 connecting first support rods 301 and second support rods 302 by applying force F thereto. The rods 301, 302 may be relatively rotated or pivoted at joint 201 such that an angle β between each first support rod 301 and second support rod 302 is larger than 180 degrees (see FIG. 5). The first support rods 301 and joints 210 move towards the underside of the sheet board 1, as shown by arrows D in FIG. 5. The first support rods 301 will also rotate at one end about the hinge connection at fastener 303.

As the second support rods 302 pivot or rotate at joint 210, they subsequently forcefully pull, via connectors 205, the legs 2 inwardly to push them under the sheet board 1, as shown by arrows G in FIG. 5. Once the sheet board has deformed slightly, as represented by the dashed line in FIG. 5, the bed legs 2 may be folded. When the connecting points between support rods 301 and support rods 302 move beyond their extreme point, the bed legs fold 2. The legs 2 rotate about the hinges of fasteners 203. As a result, the bed legs 2 are collapsed under the sheet board 1, and support legs, wires, and bed legs are positioned adjacent to the underside of the sheet board 1 in the collapsed position.

The bed 100 can be transported between locations in its collapsed position using one or more handles 1A, for example. In an embodiment, the bed 100 may also be transported between locations using handles 1A in its expanded position.

The disclosed sheet board of the bed 100 adopts an edge-coating and plastic coating technique that reduces its weight and is easier to transport. In addition, it provides supports and wires/cables that are secured in triangular configurations such that when the bed is expanded or set up, thereby providing ample support for the weight of object(s) or person(s) on the top of the sheet board. Moreover, the bed can be easily collapsed by providing hinged connections and joints for its support legs and wires/cables.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A portable and collapsible support bed comprising:
a sheet board having a top flat surface,
a plurality of legs connected to an underside of the sheet board via hinges,
support rods whose ends are connected to the underside of the sheet board and to one of the plurality of legs via hinged connections at each end, and
wire ropes connected to one of the plurality of legs and the support rods,
wherein the bed is configured for movement between an expanded position and a collapsed position, wherein the plurality of legs, support rods, and wire ropes are positioned away from the sheet board in the expanded position, and wherein the plurality of legs, support rods, and wire ropes are positioned adjacent to the underside of the sheet board in the collapsed position.

2. The bed according to claim 1, wherein the support rods are positioned and connected to the sheet board and the legs in a triangular shaped configuration when viewed from a side of the bed in the expanded position.

3. The bed according to claim 1, wherein each of the plurality of legs comprise a support leg portion and an adjustable leg portion, the support leg portion being connected to the underside of the sheet board via the hinges and the adjustable leg portion being provided within the support leg portion such that it is configured to move within and relative to a bottom of the support leg portion to adjust a height of the sheet board in its expanded position.

4. The bed according to claim 3, wherein each support leg portion includes a number of holes therein and wherein bead clamps are installed on each adjustable leg portion for movement into one of the number of holes of the support leg portion such that the adjustable leg portion can be locked in position relative to the support leg portion, thereby adjusting the height of the sheet board based on a position of the bead clamps within holes of the support leg portions.

5. The bed according to claim 1, wherein the support rods comprise a first support rod and second support rod, a first end of the first support rod being connected to the underside of the sheet board via the hinged connection, a first end of the second support rod being connected to the one of the plurality of legs via the hinged connection, and second ends of both the first support rod and the second support rod being pivotally connected to each other at a joint.

6. The bed according to claim 5, wherein the first support rod is relatively longer than the second support rod.

7. The bed according to claim 4, wherein the connection of the first support rods to the sheet board and the connection of the second support rods to the legs form multiple triangles for support, and the wire ropes make connections therewith, strengthening the triangle-shaped supports.

8. The bed according to claim 5, wherein each of the wire ropes are connected to one of the plurality of legs and the joint of the second ends of the first support rod and the second support rod.

9. The bed according to claim 5, comprising two pairs of first support rods, each pair of the first support rods having their first ends connected to the sheet board using fasteners that are positioned at side edges of the sheet board and having their second ends being pivotally connected together using the joint, to form a triangle-shaped support with respect to the sheet board, and wherein the joints of each pair of the first support rods are separate joints positioned near opposite ends of the sheet board.

10. The bed according to claim 9, comprising two pairs of second support rods, each pair of the second support rods having their first ends connected to the legs and having their second ends being pivotally connected at one of the joints to form a triangle-shaped support with respect to the legs.

11. The bed according to claim 10, wherein each of the wire ropes are connected to one of the plurality of legs and one of the joints.

12. The bed according to claim 10, comprising two pairs of the wire ropes, each pair of the wire ropes having one end connected to a different one of the legs and having an opposite end connected at one of the joints to form a V-shaped support.

13. The bed according to claim 12, wherein the wire ropes are connected to the joints and the legs in a triangular shaped configuration.

14. The bed according to claim 10, comprising four pairs of the wire ropes.

15. The bed according to claim 14, wherein, for two pairs of the four pairs of the wire ropes, the wire ropes are connected at their one ends to legs adjacent one end of the sheet board and connected at their opposite ends to a distal joint provided closer to another end of the sheet board.

16. The bed according to claim 5, comprising two pairs of second support rods, each pair of the second support rods having their first ends connected to the legs and having their second ends being pivotally connected at the joint to form a triangle-shaped support with respect to the legs.

17. The bed according to claim 1, wherein the sheet board comprises a honeycomb core material and plastic coating.

18. The bed according to claim 5, wherein the plurality of legs are configured to fold via the hinges inward towards the underside of the sheet board and wherein the joints between the first support rods and the second support rods are configured to rotate the support rods such that they move beyond their extreme point and into the collapsed position adjacent the sheet board.
